(19) United States
(12) Patent Application Publication
(10) Pub. No.: US 2023/0375014 A1
(43) Pub. Date: Nov. 23, 2023

(54) APPARATUS FOR DAMPING PRESSURE PULSATIONS

(71) Applicant: Witzenmann GmbH, Pforzheim (DE)

(72) Inventor: René RÖSLER, Karlsruhe (DE)

(73) Assignee: Witzenmann GmbH, Pforzheim (DE)

(21) Appl. No.: 18/320,533

(22) Filed: May 19, 2023

(30) Foreign Application Priority Data
May 19, 2022 (DE) 102022112647.1

(51) Int. Cl. F15B 21/00

(52) U.S. Cl. CPC F15B 21/006

(57) ABSTRACT

An apparatus (1) for damping pressure pulsations, includes: a working chamber (5) to which a working pressure (p₁) is or can be applied; and a compensation chamber (6) which is separated from the working chamber (5) by an at least partially elastic separating diaphragm (4). The apparatus (1) is distinguished in that working chamber (5) and compensation chamber (6) are connected to one another in a fluid-conducting manner via at least one line device (7).

### CROSS-REFERENCE TO RELATED APPLICATIONS

This application claims priority to German Patent Application No. 10 2022 112 647.1, filed May 19, 2022, which is incorporated herein by reference as if fully set forth.

### TECHNICAL FIELD

The invention relates to an apparatus for damping pressure pulsations.

### BACKGROUND

Known pressure pulsation dampers for hydraulic installations operate in accordance with what is known as a “2-chamber principle”. In this case, the dynamic pressure profile in a first chamber, the working chamber, is transferred to a second chamber, the compensation chamber, which is generally closed off from the surroundings and acts as mating spring, by the elasticity of a separating diaphragm, which is generally composed of plastic or thin sheet metal. The compensation chamber may be filled with air, compressed gas, a gas-oil mixture or with silicone or similar or may be preloaded with a spring.

In some instances, the compensation chamber is also displaced or sealed in relation to the working chamber by displaceable sealing rings (for example shaft seals), in order to compensate for the changes in pressure and/or volume.

The pressure pulsation is then damped owing to a different compressibility of the media, which are sealed in relation to one another, in the two chambers. More specifically, it is crucial that usually both chambers are separated from one another in a “fluid-tight” manner and are filled with different media of different compressibility. Then, the original change in volume or the resultant change in pressure (pressure pulsation) in the working chamber brings about a reaction force (force pulsation), which acts on the medium in the compensation chamber and compresses said medium to a greater or lesser extent, depending on the compressibility. In the case of identical compressibility in both chambers (which is not usual), the separating diaphragm only moves a little, thus is correspondingly “damped” only slightly. It is only in the case of absolutely incompressible media that the diaphragm does not move at all. The different compressibility thus assists the achievable damping action.

In the case of increasingly high working pressures or in the case of a wide range of the working pressure, the elastic separating diaphragm in the previously known apparatuses has to be of relatively stiff design for strength reasons, as a result of which the reactivity/elasticity of the apparatus and the damping of the pressure pulsations which are only relatively small—in comparison with the absolute working pressure—suffers and the volume compensated by deformation is only small.

Systems with displaceable separating diaphragms are not sufficiently tight, have tolerance sensitivity and are subject to wear.

In the case of preloading with higher pressures, complex safety requirements have to be complied with during fitting and transport, which in particular pushes up the costs.

### SUMMARY

The invention is based on the object of providing an improved apparatus which overcomes the disadvantages listed above and which permits a preferably settable damping of disturbing pressure pulsations in hydraulic installations, in which the absolute working pressure remains without effect on the design. Furthermore, the (preferably metallic) tight, elastic separating diaphragm is intended to be relieved of pressure. The apparatus to be provided is intended to be more reactive compared with the prior art and also to permit the damping of relatively small pressure pulsations. In this case, displaceable separating diaphragms are intended to be dispensed with and a preloading with high pressures is intended to be avoided.

This object is achieved according to the invention by an apparatus having one or more of the features disclosed herein.

Preferred refinements of the apparatus according to the invention are defined below and in the claims.

According to the invention, an apparatus for damping pressure pulsations comprises a working chamber to which a working pressure is or can be applied, and a compensation chamber which is separated from the working chamber by an at least partially elastic separating diaphragm. The apparatus is distinguished in that working chamber and compensation chamber are connected to one another in a fluid-conducting manner via at least one line device. In this case, the line device preferably has a defined length and a defined cross-sectional profile. Only certain parts of the separating diaphragm must be of (partially) elastic configuration; parts thereof, such as a cover or similar, may also be relatively stiff.

Consequently, the apparatus according to the invention is fundamentally based on a “1-chamber principle with damping throttle”. The working chamber and the compensation chamber are connected to one another in a fluid-conducting manner by a “throttle” (the above-mentioned line device) or a capillary with defined cross-sectional profile, i.e. with a determined length and with a determined (length-dependent) diameter. Here and in the following text, the terms “line device” and “throttle” are used interchangeably.

This makes it possible, in particular, for the same medium (with correspondingly identical compressibility) to be located in both chambers, as a result of which the construction of the apparatus is simplified. Furthermore, the dynamic pressure profile in the compensation chamber is delayed (that is to say damped) in relation to the dynamic working pressure profile (pressure profile in the working chamber), resulting in a pressure difference Δp between compensation chamber and working chamber. This pressure difference can, in principle, advantageously be freely set between zero (“very large” line device) and a maximum value Pmax (no line device) by the throttle design (that is to say the length, the diameter, etc. of the line device or the profile of the diameter over the length, i.e. the inner contour). By way of example, the throttle may be designed as a (Venturi) nozzle. In any case, owing to the line device, the elastic separating diaphragm “sees” only the pressure difference Δp and can thus be relieved of load from the quasi-static working pressure, since depending on the throttle design, approximately the same quasi-stationary absolute pressure prevails in working chamber and compensation chamber. As a result, the separating diaphragm can be adapted more easily to a pressure pulsation that is to be damped or that is expected or to the volume compensation desired depending on the medium. In this context, customary media are for example hydraulic liquids, oils or (cooling) water.

The change in volume which leads to a disturbing pressure pulsation is caused, in the case of a typical application, for example by a hydraulic pump which generates the working pressure and which discontinuously conveys additional working medium into a hydraulic system and compresses it. The change in volume then corresponds to the chamber volume of the pump, said chamber volume generally being substantially smaller than the total volume in the hydraulic system (depending on the pump type and the system layout, generally at most a few percent). The at least partially elastic separating diaphragm advantageously delimits or encloses a compensation volume which can be shaped (in the available installation space). Depending on the compressibility of the medium used, said compensation volume should be selected to be sufficiently great to significantly improve the damping action, that is to say in the case of (hydraulic) liquids generally considerably (i.e. by orders of magnitude) greater than the disturbing change in volume.

It should be noted in this connection that the use of a throttle or of—adjustable—throttle valves for the damping of a fluid flow is fundamentally known, and therefore use can advantageously be made of established knowledge in the design.

The apparatus according to the invention thus has a relatively simple construction and is inexpensive to produce as a result.

In principle, no wear occurs, and the apparatus according to the invention is also permanently tight with a durable design and can ensure a reliable function.

According to the invention, no preloading is required, at most a ventilation may (from time to time) be necessary.

In a corresponding refinement of the apparatus according to the invention, an advantageous separation of functions may be achieved:

A possibly present (outer) housing is preferably dimensioned in relation to the maximum absolute pressure. By contrast, the separating diaphragm is advantageously dimensioned only in relation to the considerably lower pressure difference Δp resulting from the throttle. The lower stresses associated therewith permit a durable design with simultaneously higher elasticity and thus better pressure pulsation damping in the case of high working pressures or a wide working pressure range.

It is particularly advantageous that—in a corresponding refinement—the pressure difference which arises may be adapted rapidly to a respective disturbing pressure pulsation by a simple geometrical adaptation of the throttle (which may for example be in the form of a separate, exchangeable component).

In a corresponding refinement of the invention, a simple geometrical adaptation of the throttle is achieved for example by designing the throttle as simple bore with adapted bore diameter; or as round pipe or pipe bend with adapted length and/or inner diameter inserted into a bore; or as aperture(s) with adapted flow-optimized inner cross-sectional profile which are inserted into a bore; or as a control valve which can be set from outside (as described further below); or as an (electrically, hydraulically or pneumatically controlled) control valve which can be adapted to changing boundary conditions (such as temperature or viscosity of the working medium) (as likewise described further below).

As a result, the apparatus can be adapted to a very wide pressure range in a relatively simple manner.

In addition or as an alternative, provision may be made for the throttle to be designed possibly in a dynamically adaptable or adjustable manner by way of a variable aperture or a variable length or further, similar devices, in order to compensate for varying load or media states, for example variable viscosities as a result of temperature changes.

Some particularly advantageous configurations of the apparatus according to the invention will now once again be explicitly indicated:

As has already been repeatedly noted, provision may be made in the course of an advantageous configuration of the apparatus according to the invention for the line device to act as damping throttle. This makes it possible to achieve a simple but highly effective damping of pressure pulsations, as has already been described in a detailed manner further above.

Another configuration of the apparatus according to the invention provides that, due to the connection of working chamber and compensation chamber, a dynamic pressure profile in the compensation chamber is delayed and/or damped in relation to a dynamic working pressure profile in the working chamber, resulting in a pressure difference, Δp, between compensation chamber and working chamber. Reference has also already been made to this several times further above.

In a corresponding configuration of the apparatus according to the invention, it is the case that the pressure difference can be set between a minimum value zero and a maximum value Pmax by a geometrical design of the line device, in particular with respect to the length and diameter thereof. In this way, the efficacy characteristics (characteristic curve) of the apparatus can be matched exactly to the pressure pulsations to be damped.

Yet another configuration of the apparatus according to the invention provides for the separating diaphragm to be relieved of load from a quasi-static proportion of the working pressure, since depending on a design of the line device, approximately the same quasi-stationary absolute pressure prevails in working chamber and compensation chamber. The advantages associated therewith have likewise already been described in a detailed manner further above.

Yet another refinement of the apparatus according to the invention comprises a housing, which housing receives the separating diaphragm and defines or forms the compensation chamber. Such a housing also serves as protection for the apparatus, in particular the separating diaphragm, in relation to external harmful effects.

The housing material may be selected depending on the pressure and/or depending on the medium inside and outside and/or depending on the expected temperature. Preferably, processable and weldable, corrosion-resistant high-grade steels or coated steel or fiber-reinforced plastics or—in the case of low pressures—plastic are used. A preferred embodiment comprises an (internal pressure-optimized) round pipe with cohesively attached turned parts or a deep-drawn pot.

In the course of a particularly advantageous refinement of the apparatus according to the invention, provision is made for the housing to be dimensioned in relation to a maximum absolute working pressure. Since the housing is advantageously in the form of a metallic turned part, formed part or cast part, such a dimensioning can be easily achieved.

By contrast, in the course of another, particularly advantageous refinement of the apparatus according to the invention, provision is made for the separating diaphragm to be dimensioned (only) in relation to the pressure difference, Δp, between compensation chamber and working chamber. As a result, the production of the separating diaphragm becomes much simpler and more inexpensive, and it is exposed to a significantly smaller loading during operation. The overall apparatus becomes more reactive as a result and can be used more flexibly.

It has proven to be particularly advantageous if, in a corresponding refinement of the apparatus according to the invention, the line device is in the form of an exchangeable element, in particular in the form of a separate component with respect to the housing mentioned further above. The apparatus can then be adapted to different damping requirements in a simple manner.

In the course of yet another refinement of the apparatus according to the invention, provision may be made for the line device to preferably be dynamically adaptable and/or adjustable by way of a variable aperture or a variable length. It has already been indicated that this makes it possible to compensate for varying load or media states, for example variable viscosities as a result of temperature changes.

In the course of another refinement of the apparatus according to the invention, it is in particular for this purpose additionally possible for a closed-loop and/or open-loop control unit in signal-transmitting operative connection with at least one measuring and/or sensor device to be present, which measuring and/or sensor device is configured to detect varying load or media states, for example variable viscosities as a result of temperature changes, in the working chamber and/or in the compensation chamber. The closed-loop and/or open-loop control unit is furthermore configured to perform open-loop or closed-loop control actions on at least one property of the line device, for example the length, diameter and/or opening state thereof, preferably the throughflow cross section or pressure loss thereof.

A configuration of the apparatus according to the invention in which the separating diaphragm is connected to the housing, or to a connecting piece for connecting the housing to a further article, in a pressure-resistant manner, preferably in a cohesive manner, for example by welding or soldering, has proven to be particularly advantageous. As a result of the low pressure difference according to the invention between working chamber and compensation chamber, simple adhesive connections can also be used in order to connect different materials to one another in a permanent manner, for example an extremely thin-walled high-grade steel bellows diaphragm and a plastics base or fiber composite housing. Such a connection can be produced in a simple manner and meets the requirements for the required fluid-tightness.

An extremely advantageous configuration of the apparatus according to the invention provides for the separating diaphragm to be in the form of a bellows which is closed on one side, in particular composed of metal or plastic, preferably in the form of a highly flexible, thin-walled (preferably <0.25 mm thick) bellows composed of highly formable austenitic high-grade steels. Such a structure which is closed on one side can be attached in a fluid-tight manner, in particular to said housing or a connecting piece for connecting the apparatus to further components, in a simple manner for provision of the working chamber. On account of its axially symmetrical configuration, a bellows of this kind has a well-defined elastic behavior in response to the pressure pulsations to be damped and can be adapted to the pressure volume to be compensated and the available installation space in an optimal manner via diameter, length, wall thickness, layer number, wavenumber, waveform.

In order to influence the damping action in a targeted manner, provision may also be made in yet another refinement of the apparatus according to the invention for a spring to be arranged between a housing wall of the housing and the separating diaphragm to relieve the separating diaphragm or the bellows of further load. The spring may also be used to obtain a progressive characteristic curve.

A configuration of the apparatus according to the invention in which a spring constant of the spring corresponds approximately to a spring constant of the bellows has proven to be particularly advantageous for the achievable damping action. This leads to a particularly uniform loading of the separating diaphragm.

Tests by the applicant have shown that a particularly advantageous configuration can be achieved if the spring is in the form of a helical spring, in the form of a gas bladder or in the form of a gel cushion. Such a gas bladder may be filled for example with nitrogen.

A gel cushion develops a particularly advantageous action if the medium contained therein is considerably more compressible than the surrounding liquid. Provision may therefore preferably be made for the gel cushion to be filled with a mixture of a liquid (very preferably inexpensive and chemically neutral) and a gas (for example nitrogen or air bubbles). A particular advantage of this gas/liquid mixture is the adaptability of the compressibility, that is to say of the spring rate of the cushion.

In both cases (gas bladder or gel cushion), the inner medium is preferably held in a permanently tight and elastic envelope composed of plastic, rubber or silicone or in a flexible metal diaphragm in the compensation chamber.

Another refinement of the apparatus according to the invention provides for the line device to be arranged in the separating diaphragm. This leads to a particularly simple apparatus that is inexpensive to produce.

By contrast, another refinement of the apparatus according to the invention is distinguished in that the line device is arranged in the above-mentioned connecting piece. This makes it possible to achieve a particularly stable configuration in the region of the line device.

Furthermore, a refinement of the apparatus according to the invention in which a delimited volume is formed in the compensation chamber, preferably by a diaphragm cell or an elastomer bladder, which volume is filled with a compressible medium, has proven to be advantageous. A suitable selection of properties of the compressible medium makes it possible to influence the damping behavior of the apparatus in a targeted manner. Further advantageous properties of the medium may be: price, availability, chemical neutrality (in relation to the envelope), chemical resistance/stability, environmental compatibility.

A configuration of the apparatus according to the invention in which the line device is configured to be at least partially closable in one direction by suitable valve, in order to—analogously to a shock absorber—enable different damping in the direction of tension and of compression and in order to compensate for a rapid build-up of or drop in pressure, has also proven to be extremely advantageous.

A configuration of the apparatus according to the invention which can be produced in a particularly simple and thus inexpensive manner is produced if, in a corresponding refinement, the line device is in the form of a bore, preferably in a housing wall of the housing or in the connecting piece.

Another advantageous configuration of the apparatus according to the invention comprises a sensor for travel detection or closed-loop control, for example for function monitoring or overload detection, which sensor is preferably arranged between the separating diaphragm and a housing wall of the housing. The sensor preferably makes it possible, for example, to measure the temperature of a medium contained in the apparatus (the viscosity of the working medium is generally temperature-dependent and will change within a wide range during operation in dependence on the surroundings and internal friction). Such a configuration makes it possible to detect or influence a functional state (for example a diaphragm deflection) of the apparatus in a targeted manner. Said sensor may alternatively for example be a (proximity) switch, which detects a deflection of the separating diaphragm.

A configuration in which the sensor is mounted externally on the housing of the apparatus is particularly advantageous; a housing orifice (that is to say a potential weak point with respect to pressure load and tightness) can then be avoided. In this connection, use of inductive, capacitive or magnetic field sensors is possible.

Yet another configuration of the apparatus according to the invention provides for said connecting piece to project at least in certain portions into the bellows and for the compensation chamber to be at least partially in the form of a cut-out in the connecting piece, preferably in the form of a cut-out or bore along a longitudinal axis of the bellows, which cut-out is connected to the working chamber in a fluid-conducting manner via the line device (throttle).

The aforementioned configuration makes it possible to achieve a variant with a limited working stroke of the elastic separating diaphragm—in particular if a free end of the connecting piece, said free end being located within the bellows, and a housing wall of the housing, said housing wall lying opposite to this end, also function as stop surfaces for respectively limiting a working stroke of the separating diaphragm.

In this connection, an improved function with self-adjusting throttle may additionally be provided by corresponding refinement. For this purpose, provision may be made in a corresponding configuration of the apparatus according to the invention for a throttle element to be movably arranged within the cut-out, and for an outer wall of the throttle element, which is mechanically connected to the separating diaphragm, and a delimiting surface of the cut-out to form a preferably ring-shaped fluid gap, the cross-sectional area and/or length of which varies depending on a differential pressure-dependent position of the separating diaphragm, such that a throttling action which is defined over a working range of the separating diaphragm and which is preferably degressive with increasing stroke of the separating diaphragm is produced.

Specifically, in order to implement this idea, provision may be made for the throttle element to be of tubular configuration and to be mechanically connected to the separating diaphragm, said fluid gap, preferably a ring gap, remaining between the outer wall of the throttle element and a delimiting surface of the cut-out, and the throttle element being located, in a first state, with its outer wall in the region of an opening of the line device into the cut-out, and, in a second state, owing to deformation of the separating diaphragm, with its outer wall outside said opening of the line device.

In said first state, the throttle element at least partially closes the opening of the line device by way of its outer wall, while in said second state, said closure action is canceled and fluid or medium can flow through the tubular throttle element practically unimpeded.

Such a configuration is particularly effective if, in a corresponding refinement of the apparatus, the throttle element is of rectilinear configuration and is arranged with its longitudinal axis aligned with a longitudinal axis of the cut-out.

This achieves a self-adjusting throttle construction, here in the particular configuration with ring gap-shaped throttle, which is configured around an axially displaceable, tubular control valve (throttle element), which throttle element is preferably fixedly connected to the elastic separating diaphragm. In the case of rapid great changes in pressure, a relatively great throttle cross section thus opens, as a result of which the pressure within the working chamber can be adapted to the new working pressure more rapidly.

In this way, the working stroke of the elastic separating diaphragm is additionally structurally limited, such that stops can be reliably avoided. In principle, this avoids excessively great strokes or deformations of the elastic separating diaphragm, which constitutes an effective overload protection.

### BRIEF DESCRIPTION OF THE DRAWINGS

Further properties and advantages of the invention emerge from the following description of exemplary embodiments on the basis of the drawing.

FIG. 1 shows a first configuration of the apparatus according to the invention together with illustrative graphs;

FIG. 2 shows a second configuration of the apparatus according to the invention;

FIG. 3A shows a third configuration of the apparatus according to the invention;

FIG. 3B shows a modification of the third configuration of the apparatus according to the invention;

FIG. 4 shows a fourth configuration of the apparatus according to the invention;

FIG. 5 shows a fifth configuration of the apparatus according to the invention;

FIG. 6 shows a sixth configuration of the apparatus according to the invention;

FIG. 7A shows a seventh configuration of the apparatus according to the invention;

FIG. 7B shows a modification of the seventh configuration of the apparatus according to the invention;

FIG. 8 shows the configuration from FIG. 7A with an additional, movable throttle element;

FIG. 9A shows another configuration of the apparatus according to the invention; and

FIG. 9B shows a modification of the configuration from FIG. 9A.

### DETAILED DESCRIPTION

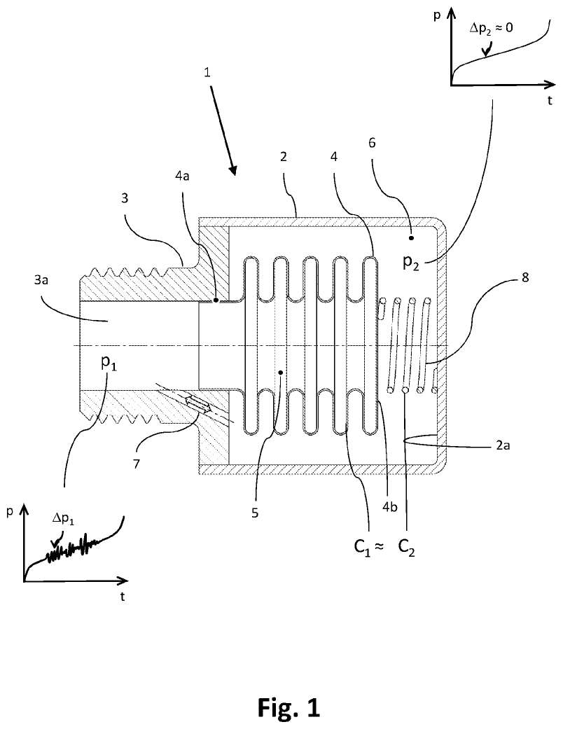

FIG. 1 illustrates an apparatus 1 according to the invention in a longitudinal section. An elastic separating diaphragm in the form of a (metal) bellows 4, which bellows 4 is of closed configuration on one side, is arranged within a housing 2, which housing 2 has, on its one side, a connecting or connection piece 3 for connecting to a further component (not shown). At its other, open end, the bellows 4 is attached, at reference sign 4a, all the way around peripherally in a cohesive and fluid-tight manner in the region of an orifice 3A of the connecting piece 3. The connecting piece 3 is, for its part, connected to the housing 2 in a fluid-tight and cohesive manner, as illustrated.

In this way, a working chamber 5 is configured within the bellows 4, while a compensation chamber 6 is formed within the housing 2, around the bellows 4, which compensation chamber 6 is separated from the working chamber 5 by the elastic separating diaphragm, i.e. the bellows 4. Working chamber 5 and compensation chamber 6 are, however, connected to one another in a fluid-conducting manner via a line device or throttle 7, as illustrated. In the shown configuration of the apparatus 1, the line device or throttle 7 is in the form of an (oblique) bore through the connecting piece 3.

A spring 8 is arranged between the closed end of the bellows 4 (at reference sign 4b) and a housing wall 2a of the housing 2, said housing wall lying opposite to this end 4b, which spring 8 in the case of corresponding expansion of the bellows 4 cooperates with the bellows 4 so as to generate a restoring force. Advantageously, a spring constant C₁ of the bellows 4 corresponds approximately to a spring constant C₂ of the spring 8, i.e. C₁≈C₂. The spring 8 constitutes merely an optional feature of the shown configuration and can in principle be dispensed with.

FIG. 1 also illustrates that a working pressure p₁ prevails within the working chamber 5, while a (compensation) pressure p₂ prevails in the compensation chamber 6. However, the separating diaphragm, i.e. the bellows 4, “sees” only a differential pressure or pressure difference Δp between these two pressures, which pressure difference is accompanied by a change in volume ΔV of the bellows 4, as shown, which change in volume leads to the already mentioned expansion of the bellows 4. Said pressure difference and the damping of pressure pulsations is influenced by properties of the line device or throttle 7, in particular the length and/or diameter thereof, and by properties of a medium (fluid) present in the working chamber 5 or compensation chamber 6, in particular the temperature-dependent density and/or viscosity thereof.

The damping action of the shown apparatus 1 for pressure pulsations is illustrated in two graphs in FIG. 1: the time-dependent pressure in the region of the working chamber 5 is illustrated on the left. The corresponding curve shows clearly identifiable pressure oscillations or pressure pulsations Δp₁. The corresponding time-dependent pressure profile in the region of the compensation chamber is shown on the right. Here, the pressure oscillations or pressure pulsations have essentially disappeared, Δp₂≈0.

The Figures which are described below show further configurations of the apparatus 1 according to the invention. In this case, identical reference signs denote identical or at least identically acting elements. For the purposes of a readable illustration, all the individual apparatus elements are not discussed in a detailed manner again, but rather reference is essentially made only to the respective particular features.

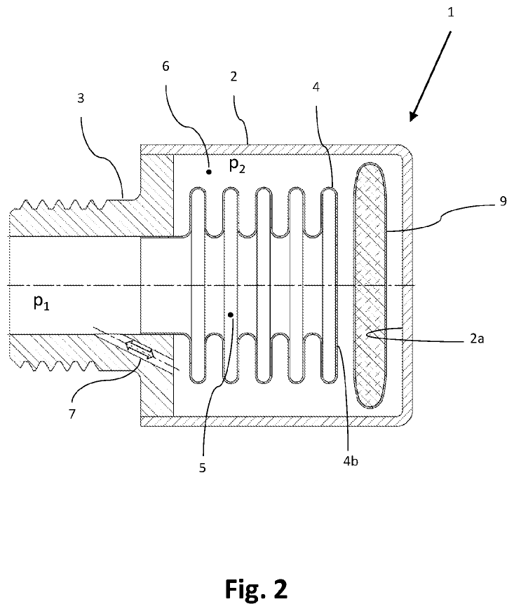

According to the configuration in FIG. 2, instead of the spring 8 (cf. FIG. 1), a gas bladder or a gel cushion 9, which can be filled with a particular medium, which medium has specific compression properties in order to influence the damping action of the apparatus 1 overall, is arranged in the compensation chamber 6 between the bellows end 4b and the housing wall 2a.

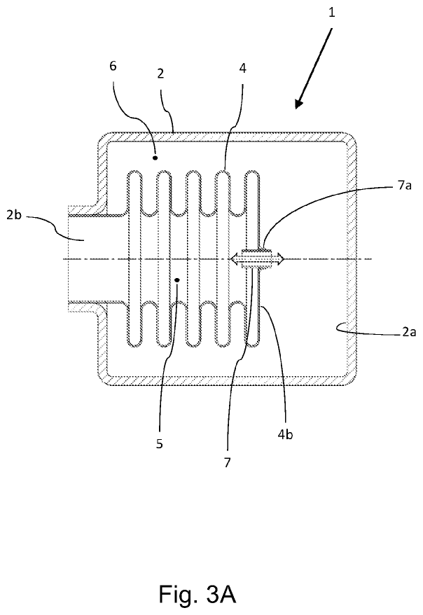

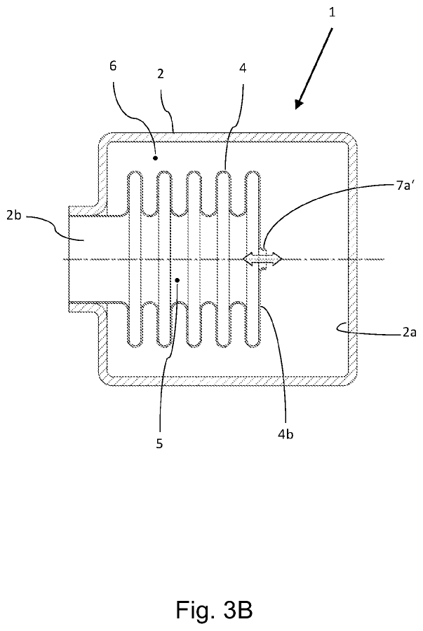

According to the configuration in FIG. 3A, the connecting piece 3 (cf. FIG. 1) can be dispensed with. Here, the bellows 4 is or can be connected directly (in a cohesive manner) to the housing 2 in the region of a housing opening 2b. The line device or throttle 7 is configured in the bellows 4 itself, specifically in the form of a tubular insert 7a in the closed bellows end 4b, through which fluid can flow according to the double arrow shown in FIG. 3A. In particular, but not only in this configuration, the line device 7 may be of exchangeable configuration in order to adapt a damping characteristic curve to certain conditions, for example by corresponding exchange of the tubular insert 7a.

According to the configuration in FIG. 3B, the throttle is in the form of a simple orifice 7a′ in the closed bellows end 4b; the tubular insert (cf. FIG. 3A) is omitted.

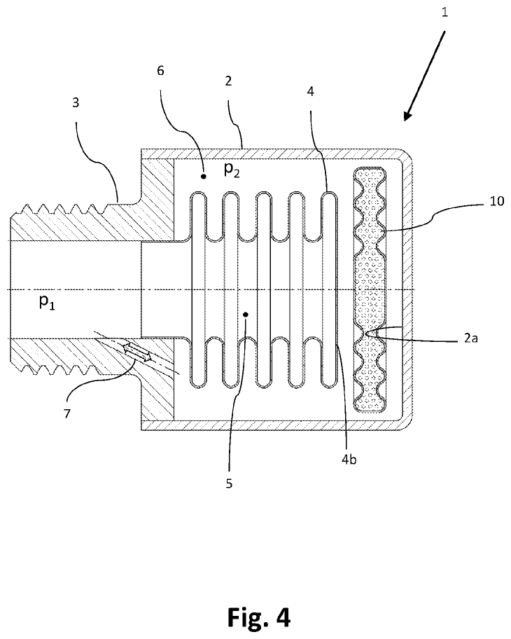

The configuration according to FIG. 4 corresponds substantially to the configuration in FIG. 2. Here, the gas bladder or the gel cushion 9 has been replaced by a diaphragm cell 10, which diaphragm cell 10 is filled with a compressible medium.

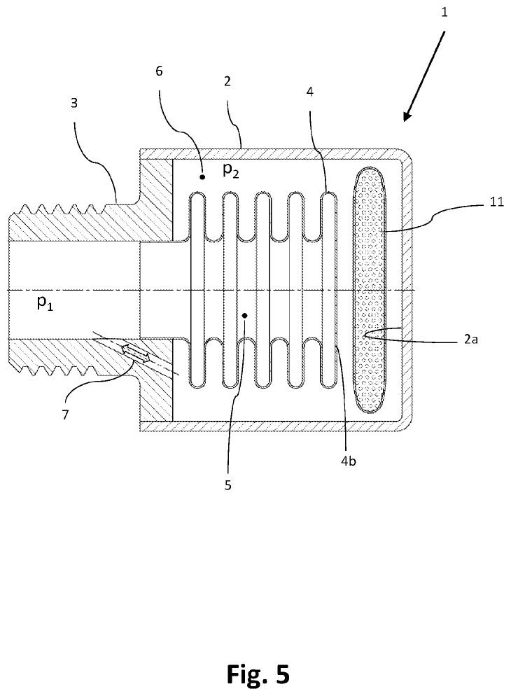

In the configuration according to FIG. 5, the diaphragm cell 10 (cf. FIG. 4) has in turn been replaced by an elastomer bladder 11, which elastomer bladder 11 is likewise filled with a compressible medium.

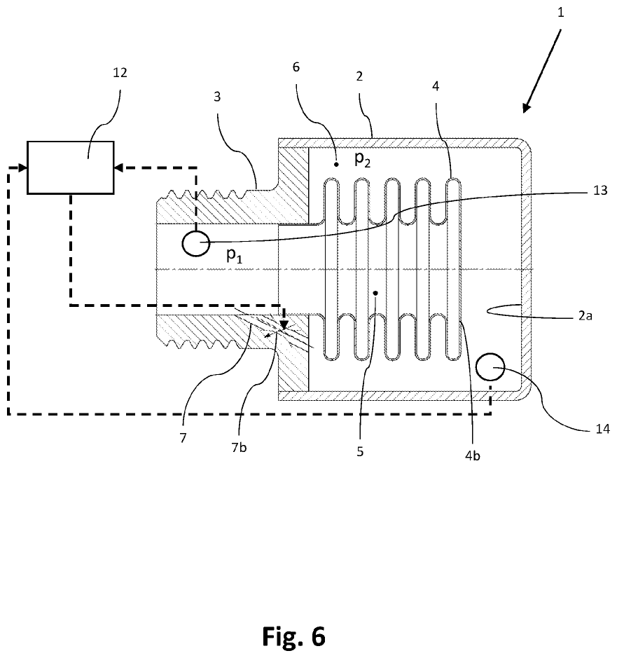

The apparatus 1 according to the configuration in FIG. 6 initially corresponds substantially to the configuration according to FIG. 1, without the optional spring 8 shown therein. In addition, the configuration in FIG. 6 has a closed-loop and/or open-loop control unit 12 which is in signal-transmitting operative connection with two measuring and/or sensor device 13, 14 and which is configured to detect varying load or media states, for example variable viscosities as a result of temperature changes, in the working chamber 5 and/or in the compensation chamber 6. To this end, the one measuring/sensor device 13 is arranged in the working chamber 5 and the other measuring/sensor device 14 is arranged in the compensation chamber 6. The closed-loop and/or open-loop control unit 12 is configured to perform, in accordance with the stipulations of the measuring/sensor device 13, 14 (for example in the form of pressure and/or temperature sensors), open-loop or closed-loop control actions on at least one property of the line device, in the present case on a valve 7b arranged on or in the line device 7, in order to (partially) open and/or close the line device 7.

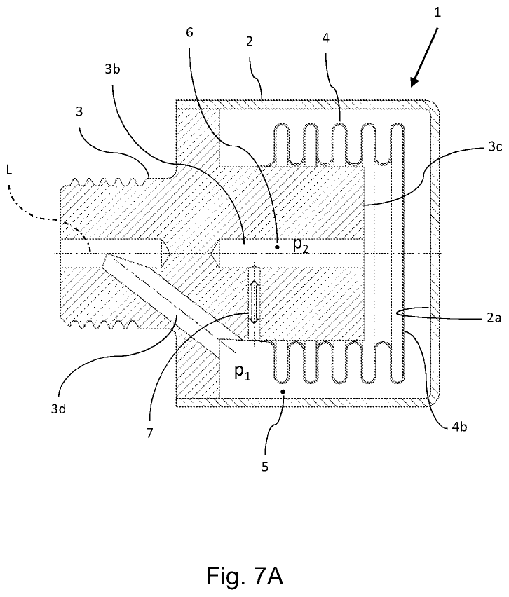

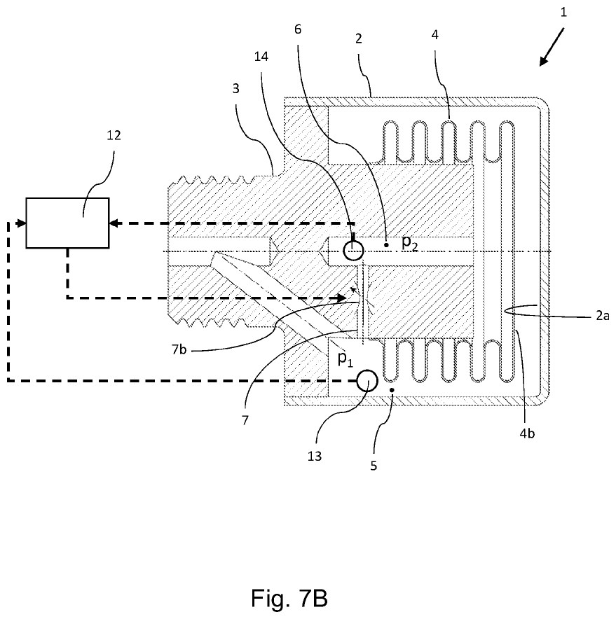

FIG. 7A shows a fundamentally differently constructed configuration of the apparatus 1 according to the invention, in which the connecting or connection piece 3 (cf. FIG. 1) extends relatively far into the housing 2 and also into the bellows 4. The compensation chamber 6 is partially formed by a central bore or cut-out 3b in the connecting piece 3, which bore or cut-out 3b extends along a longitudinal axis L of the connecting piece 3, which longitudinal axis L is aligned with a longitudinal axis of the bellows 4. The housing wall at reference sign 2a, which has already been mentioned several times, and an end-side end 3c of the connecting piece 3, said end being located in the bellows 4, function as stops (stop surfaces) for a stroke movement of the bellows 4. The bellows 4 is laterally peripherally fastened to the connecting piece 3 in a cohesive manner. A fluidic connection between the surroundings and the working chamber 5 is formed by an (obliquely running) bore 3d through the connecting piece 3. A further bore, which functions as the line device or throttle 7, leads from the interior space of the housing 2 through the connecting piece 3 into the region of said cut-out 3b. In FIG. 7A, working chamber 5 and compensation chamber 6 have thus been interchanged to some extent in relation to the previously shown configurations (cf. the corresponding indications p₁ and p₂).

FIG. 7B shows a combination of the configuration according to FIG. 7A with parts of the apparatus according to FIG. 6. Thus, the configuration in FIG. 7B also has a closed-loop and/or open-loop control unit 12 which is in signal-transmitting operative connection with two measuring and/or sensor device 13, 14 and which is configured to detect varying load or media states, for example variable viscosities as a result of temperature changes, in the working chamber 5 and/or in the compensation chamber 6. To this end, the one measuring/sensor device 13 is arranged in the working chamber 5 and the other measuring/sensor device 14 is arranged in the compensation chamber 6. The closed-loop and/or open-loop control unit 12 is configured to perform, in accordance with the stipulations of the measuring/sensor device 13, 14 (for example in the form of pressure and/or temperature sensors), open-loop or closed-loop control actions on at least one property of the line device, in the present case on a valve device 7b arranged on or in the line device 7, in order to (partially) open and/or close the line device 7.

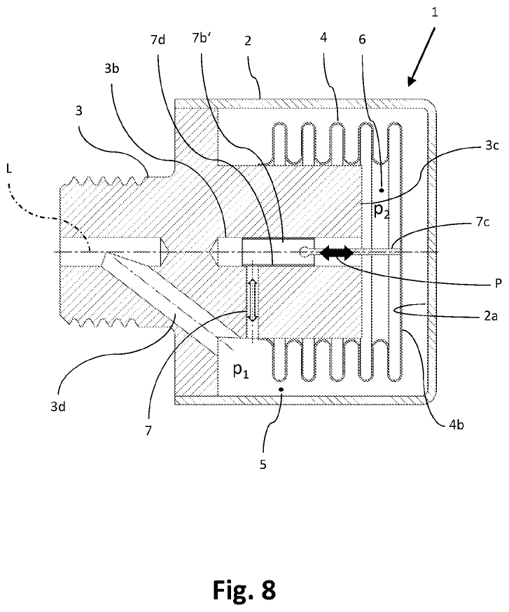

FIG. 8 shows a refinement of the configuration according to FIG. 7A (or 7B; control unit etc. are not illustrated), in which a throttle element (or valve element) 7b′ is arranged within the bore or cut-out 3b, which throttle element is in the form of a rectilinear pipe portion. A longitudinal axis of said pipe portion is aligned with the already mentioned longitudinal axis L of the connecting piece 3 or with the longitudinal axis of the bellows 4. The throttle element 7b′ is fixedly connected to the end 4b of the bellows 4 by a (mechanical) connecting element 7c, with the result that the throttle element 7b′ moves within the bore 3b when the bellows 4 is deformed by pressure actions (cf. the double arrow P in FIG. 8).

In a first, unloaded state of the apparatus 1 or of the bellows 4, the throttle element 7b′ is arranged (cf. FIG. 8) in such a way that it is located with its outer wall 7d in front of a mouth of said further bore or line device 7 into the cut-out 3b and thus largely closes the line device 7 (except for a relatively small ring gap between a wall of the cut-out 3b and said outer wall 7d). If the bellows 4 is now deflected toward the right, the throttle element 7b′ moves in the same direction and successively frees up said mouth. A liquid located within the cut-out 3b can then also flow inward through the pipe portion, such that a damping characteristic curve of the apparatus 1 changes accordingly.

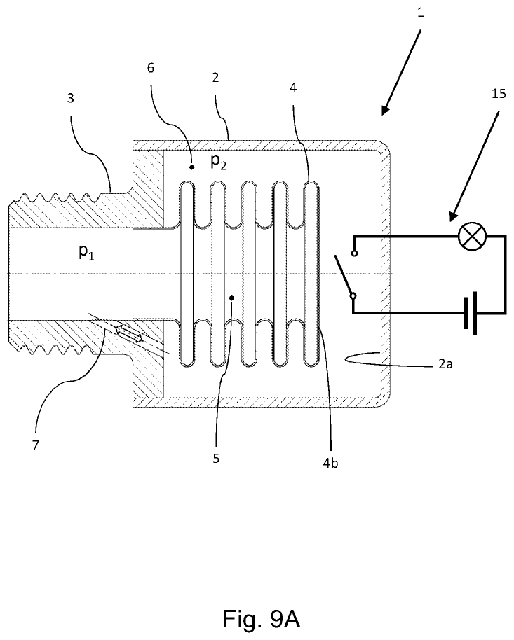

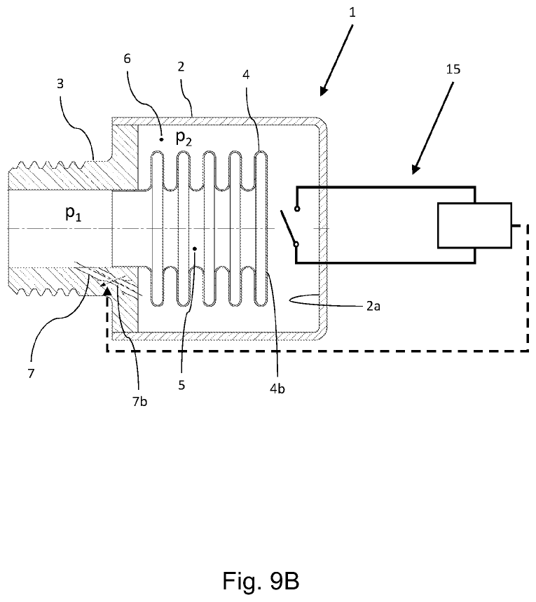

Furthermore, FIG. 9A shows a configuration which corresponds substantially to FIG. 1 (without the spring 8 therein). A generic sensor 15—here illustrated symbolically in the form of a simple mechanical switch with connected circuit—is arranged in the region of the housing wall 2a which has already been mentioned several times, which sensor 15 can be used to detect and display a determined degree of deflection of the bellows 4 and to trigger suitable open-loop or closed-loop control operations, for example for a change of properties of the line device 7.

This is finally schematically illustrated again in FIG. 9B. The sensor 15 is used to detect and display a determined degree of deflection of the bellows 4 and to trigger suitable open-loop or closed-loop control operations, for example for a change of properties of the line device 7. According to FIG. 9B, provision is made for open-loop or closed-loop control actions to be performed on at least one property of the line device, in the present case again on a valve 7b arranged on or in the line device 7, in order to (partially) open and/or close the line device 7.

1. An apparatus (1) for damping pressure pulsations (Δp₁), the apparatus comprising:
a working chamber (5) to which a working pressure (p₁) is applicable;
a compensation chamber (6) which is separated from the working chamber (5) by an at least partially elastic separating diaphragm (4); and
a line device (7) which fluidically connects the working chamber (5) and the compensation chamber (6) to one another.

2. The apparatus (1) as claimed in claim 1, wherein the line device (7) acts as a damping throttle.

3. The apparatus (1) as claimed in claim 1, wherein, due to the connection of the working chamber (5) and the compensation chamber (6), a dynamic pressure profile (p₂(t)) in the compensation chamber (6) is at least one of delayed or damped in relation to a dynamic working pressure profile (p₁(t)) in the working chamber (5), resulting in a pressure difference, Δp, between the compensation chamber (6) and the working chamber (5).

4. The apparatus (1) as claimed in claim 3, wherein the pressure difference (Δp) is settable between a minimum value zero and a maximum value Pmax by a geometrical design of the line device (7).

5. The apparatus (1) as claimed in claim 1, wherein the separating diaphragm (4) is relieved of load from a quasi-static proportion of the working pressure (p₁) due to an approximately same quasi-stationary absolute pressure prevailing in the working chamber (5) and the compensation chamber (6) based on the line device (7).

6. The apparatus (1) as claimed in claim 1, further comprising a housing (2) which receives the separating diaphragm (4) and defines the compensation chamber (6).

7. The apparatus (1) as claimed in claim 6, wherein the housing (2) is dimensioned in relation to a maximum absolute working pressure.

8. The apparatus (1) as claimed in claim 3, wherein the separating diaphragm (4) is dimensioned in relation to the pressure difference, Δp, between the compensation chamber (6) and the working chamber (5).

9. The apparatus (1) as claimed in claim 6, wherein the line device (7) comprises an exchangeable element formed as a separate component with respect to the housing (2).

10. The apparatus (1) as claimed in claim 1, wherein the line device (7) is at least one of adaptable or adjustable by a variable aperture or a variable length.

11. The apparatus (1) as claimed in claim 1, further comprising at least one of a closed-loop or open-loop control unit (12) in signal-transmitting operative connection with at least one of a measuring or sensor device (13, 14), said at least one of a measuring or sensor device (13, 14) is configured to detect at least one of a varying load or media states in at least one of the working chamber (5) or the compensation chamber (6), said control unit (12) is configured to perform at least one of open-loop or closed-loop control actions on at least one property of the line device (7).

12. The apparatus (1) as claimed in claim 6, wherein the separating diaphragm (4) is connected to the housing (2), or to a connecting piece (3) for connecting the housing (2) to a further article, in a pressure-resistant manner.

13. The apparatus (1) as claimed in claim 1, wherein the separating diaphragm (4) comprises a bellows which is closed on one side.

14. The apparatus (1) as claimed in claim 13, further comprising a housing (2) which receives the separating diaphragm (4) and defines the compensation chamber (6), and a spring (8) arranged between a housing wall (2a) of the housing (2) and the separating diaphragm (4).

15. The apparatus (1) as claimed in claim 14, wherein a spring constant (C₂) of the spring (8) corresponds approximately to a spring constant (C₁) of the bellows (4).

16. The apparatus (1) as claimed in claim 15, wherein the spring (8) comprises a helical spring, a gas bladder (9), a diaphragm cell (10) or a gel cushion.

17. The apparatus (1) as claimed in claim 1, wherein the line device (7) is arranged in the separating diaphragm (4).

18. The apparatus (1) as claimed in claim 12, wherein the line device (7) is arranged in the connecting piece (3).

19. The apparatus (1) as claimed in claim 1, wherein a delimited volume is formed in the compensation chamber (6), and said volume is filled with a compressible medium.

20. The apparatus (1) as claimed in claim 1, further comprising a valve (7b), and the line device (7) is configured to be at least partially closable at least in one direction by the valve (7b).

21. The apparatus (1) as claimed in claim 6, wherein the line device (7) comprises a bore in a housing wall of the housing (2) or in a connecting piece (3) for connecting the housing (2) to a further article.

22. The apparatus (1) as claimed in claim 6, further comprising a sensor (15) for travel detection or closed-loop control, and the sensor (15) is arranged between the separating diaphragm (4) and a housing wall (2a) of the housing (2).

23. The apparatus (1) as claimed in claim 13, further comprising a housing (2) which receives the separating diaphragm (4) and defines the compensation chamber (6), a connecting piece (3) for connecting the housing (2) to a further article projects at least in certain portions into the bellows (4), the compensation chamber (6) is at least partially in the form of a cut-out (3b) in the connecting piece (3), and the cut-out (3b) is connected to the working chamber (5) in a fluid-conducting manner via the line device (7).

24. The apparatus (1) as claimed in claim 23, wherein the connecting piece (3) has a free end (3c), said free end being located within the bellows (4), and a housing wall (2a) of the housing (2), said housing wall lying opposite to the free end (3c), functions as stop surfaces for limiting a working stroke of the separating diaphragm (4).

25. The apparatus (1) as claimed in claim 24, further comprising a throttle element (7b′) movably arranged within the cut-out (3b), an outer wall (7d) of the throttle element (7b′), which is mechanically connected to the separating diaphragm (4), and a delimiting surface of the cut-out (3b) form a fluid gap, at least one of a cross-sectional area or a length of the fluid gap varies depending on a differential pressure-dependent position of the separating diaphragm (4), such that a throttling action which is defined over a working range of the separating diaphragm (4) is produced.

26. The apparatus (1) as claimed in claim 25, wherein the throttle element (7b′) is tubular, the fluid gap remains between an outer wall (7d) of the throttle element (7b′) and a delimiting surface of the cut-out (3b), and the throttle element (7b′) is located, in a first state, with the outer wall (7d) in a region of an opening of the line device (7), and, in a second state, due to deformation of the separating diaphragm (4), with the outer wall outside an opening of the line device (7).

27. The apparatus (1) as claimed in claim 26, wherein the throttle element (7b′) comprises a rectilinear pipe portion and is arranged with a longitudinal axis thereof aligned with a longitudinal axis of the cut-out (3b).
